(19) United States
(12) Patent Application Publication
(10) Pub. No.: US 2026/0231311 A1
(43) Pub. Date: Aug. 6, 2026

(54) SINGLE LIVE WIRE LIGHTING SYSTEM

(71) Applicant: XIAMEN LUXUNI INDUSTRIAL DESIGN LTD., Fujian (CN)

(72) Inventors: Jin CHEN, Fujian (CN); Chao FANG, Fujian (CN); Huanggui LIN, Fujian (CN); Jisheng MA, Fujian (CN)

(21) Appl. No.: 19/454,466

(22) Filed: Jan. 21, 2026

(30) Foreign Application Priority Data
Jan. 24, 2025 (CN) 2025201681757

(51) Int. Cl. H05B 47/17; H02J 9/06; H05B 47/155; H05B 47/19

(52) U.S. Cl. CPC H05B 47/172; H02J 9/065; H02J 9/068; H05B 47/155; H05B 47/19

(57) ABSTRACT

A single live wire lighting system, having at least one single live wire lighting unit; each single live wire lighting unit has a power supply live wire, a power supply neutral wire, an uninterrupted power control switch connected in series between an input side and an output side of the power supply live wire, and at least one lighting module that connect with the power supply live wire and the power supply neutral wire; each light module is controlled by a corresponding lighting module. The single live wire lighting system can be conveniently arranged directly on conventional power supply lines.

### BACKGROUND OF THE INVENTION

The present invention relates to the field of lighting systems, specifically to a single live wire lighting system.

To meet the lighting needs during normal power supply and the emergency lighting needs during unexpected power outages, as shown in FIG. 1, existing lighting systems with emergency lighting functions are provided with both an emergency lighting power supply (with a built-in battery) and a normal lighting power supply (also known as the mains power supply) to power the light source. The emergency lighting power supply is directly connected to the mains live wire L and the mains neutral wire N, while the normal lighting power supply is connected to the mains neutral wire N and connected to the mains live wire L through a wall switch SW. This setup, on one hand, ensures that the emergency lighting power supply can be continuously charged, guaranteeing that the emergency lighting power supply has sufficient power to drive the light source to illuminate in case of an unexpected power outage; on the other hand, operation of the normal lighting power supply can be controlled by the wall switch SW. When the wall switch SW is switched on to power up the normal lighting power supply, the normal lighting power supply provides power to the light source and thus illuminating the light source. When the wall switch SW is switched off to discontinue the power supply to the normal lighting power supply, the normal lighting power cuts off the power supply to the light source and thus causing the light source to turn off.

However, in the aforementioned lighting system, since a wall switch SW is required, it necessitates the addition of an extra live wire L2 for connecting the emergency lighting power supply on traditional power supply lines (which comprises a power supply live wire L1' and the power supply neutral wire N1' connected to the mains live wire L and the mains neutral wire N respectively, wherein said power supply live wire L1' is connected in series with the wall switch SW). The power supply live wire L1' and the power supply neutral wire N1' are used to connect the normal lighting power supply to the mains live wire L and the mains neutral wire N, while the additional live wire L2 and the power supply neutral wire N1' are used to connect the emergency lighting power supply to the mains live wire L and the mains neutral wire N. As can be seen from the above, arranging the aforementioned lighting system on traditional power supply lines requires the additional arrangement of the extra live wire L2, which necessitates rewiring and presents the problem of cumbersome installation

In view of the aforementioned issues, it is necessary to develop a single live wire lighting system that can be directly installed on traditional power supply lines, thereby providing the advantage of easy installation.

### BRIEF SUMMARY OF THE INVENTION

It is an object of the present invention to provide a single live wire lighting system that can be directly installed on traditional power supply lines, thereby providing the advantage of easy installation.

To fulfil the above object, the present invention provides the following technical solutions:

A single live wire lighting system, comprising at least one single live wire lighting unit; each of said at least one single live wire lighting unit comprises a power supply live wire, a power supply neutral wire, an uninterrupted power control switch, and at least one lighting module; the uninterrupted power control switch is connected in series between an input side and an output side of the power supply live wire, and the uninterrupted power control switch is biased to an uninterrupted state that allows continuous electrical connection between the input side and the output side of the power supply live wire; each of said at least one lighting module comprises a switch control module, at least one light source, and at least one power module that connects the switch control module and said at least one light source; an input side of the switch control module is connected to the output side of the power supply live wire and also to the power supply neutral wire; each of said at least one power module of each of said at least one lighting module of each of said at least one single live wire lighting unit comprises at least one of an emergency lighting power supply and a normal lighting power supply to supply power to a respective light source, and at least one of said at least one power module comprises the emergency lighting power supply; the uninterrupted power control switch of each of said at least one single live wire lighting unit is configured to send control signals; in each of said at least one single live wire lighting unit, the switch control module of each of said at least one lighting module receives and parses the control signals sent by the uninterrupted power control switch, and the switch control module of each of said at least one lighting module controls whether a respective power module of a respective lighting module supplies power to a respective light source based on the control signals.

Each of said at least one power module of each of said at least one lighting module of each of said at least one single live wire lighting unit comprises both the emergency lighting power supply and the normal lighting power supply; the switch control module of each of said at least one lighting module controls whether the normal lighting power supply of a respective power module of a respective lighting module supplies power to a respective light source based on the control signals.

In each of said at least one lighting module where each of said at least one power module only comprises the emergency lighting power supply, the switch control module of each of said at least one lighting module where each of said at least one power module only comprises the emergency lighting power supply controls whether the emergency lighting power supply of a respective power module of a respective lighting module supplies power to a respective light source based on the control signals.

In each of said at least one lighting module where each of said at least one power module only comprises the normal lighting power supply, the switch control module of each of said at least one lighting module where each of said at least one power module only comprises the normal lighting power supply controls whether the normal lighting power supply of a respective power module of a respective lighting module supplies power to a respective light source based on the control signals.

The control signals are wireless control signals, or the control signals are wired signals loaded onto the power supply live wire.

The single live wire lighting system further comprises a master control mechanism; the master control mechanism comprises a main live wire, a main neutral wire, and an uninterrupted power master control switch connected in series between an input side and an output side of the main live wire; the input side of the power supply live wire of each of said at least one single live wire lighting unit is connected to the output side of the main live wire; the power supply neutral wire of each of said at least one single live wire lighting unit is connected to the main neutral wire; the uninterrupted power master control switch is configured to send master control signals; the switch control module of each of said at least one lighting module of each of said at least one single live wire lighting unit receives the master control signals sent by the uninterrupted power master control switch, and the switch control module of each of said at least one lighting module controls whether a respective power module of a respective lighting module supplies power to a respective light source based on the master control signals.

Circuit structures of the uninterrupted power master control switch are the same as those of the uninterrupted power control switch.

The uninterrupted power control switch comprises a single live wire power-taking circuit, a mechanical switch circuit, and a control circuit; the single live wire power-taking circuit is connected in series between the input side and the output side of the power supply live wire, and the single live wire power-taking circuit is provided with a single live wire relay that controls power connection between the input side and the output side of the power supply live wire; the control circuit is powered by the single live wire power-taking circuit and is connected to the single live wire relay and the mechanical switch circuit; the control circuit controls, based on signals from the mechanical switch circuit, an on/off state, an on/off frequency, and an on/off duration of the single live wire relay.

The switch control module comprises a main control circuit, a power supply circuit, a signal detection isolation circuit, and an electronic switch circuit; the power supply circuit is connected to the output side of the power supply live wire and also to the power supply neutral wire; the signal detection isolation circuit is connected to the output side of the power supply live wire and also to the power supply neutral wire; the main control circuit is connected to the power supply circuit, the signal detection isolation circuit, and the electronic switch circuit; the main control circuit and the signal detection isolation circuit are powered by the power supply circuit; the main control circuit receives the control signals sent by the uninterrupted power control switch through the signal detection isolation circuit, and the main control circuit correspondingly controls an on/off state of the electronic switch circuit based on the control signals; the electronic switch circuit is connected to a corresponding power module.

The signal detection isolation circuit comprises a resistor R7-2, a resistor R8-2, a resistor R9-2, a capacitor C5-2, a Zener diode ZD2-2, and an optocoupler U6-2; a positive electrode of an input side of the optocoupler U6-2 is connected to the output side of the power supply live wire; a negative electrode of the input side of the optocoupler U6-2 is connected to a negative electrode of the Zener diode ZD2-2 through the resistor R8-2 and the resistor R9-2; a positive electrode of the Zener diode ZD2-2 is connected to the power supply neutral wire; a positive electrode of an output side of the optocoupler U6-2 is connected to the main control circuit and a first terminal of the capacitor C5-2, and the positive electrode of the output side of the optocoupler U6-2 is also connected to the power supply circuit through the resistor R7-2; a negative electrode of the output side of the optocoupler U6-2 and a second terminal of the capacitor C5-2 are grounded.

By using the above technical solutions, when installing the single live wire lighting system of the present invention on traditional power supply lines (which comprise a power supply live wire and a power supply neutral wire, with the power supply live wire connected in series with a wall switch), the uninterrupted power control switch of each single live wire lighting unit can directly replace the wall switch or be installed inside the wall switch and be connected in series between the input side and the output side of the power supply live wire, and each lighting module can be directly connected to the power supply neutral wire and also to the output side of the power supply live wire. Thus, it is evident that the single live wire lighting system of the present invention can be directly installed on traditional power supply lines without the need for rewiring, thus providing the advantage of easy installation.

### BRIEF DESCRIPTION OF THE DRAWINGS

FIG. 1 is a schematic diagram of a prior art lighting system.

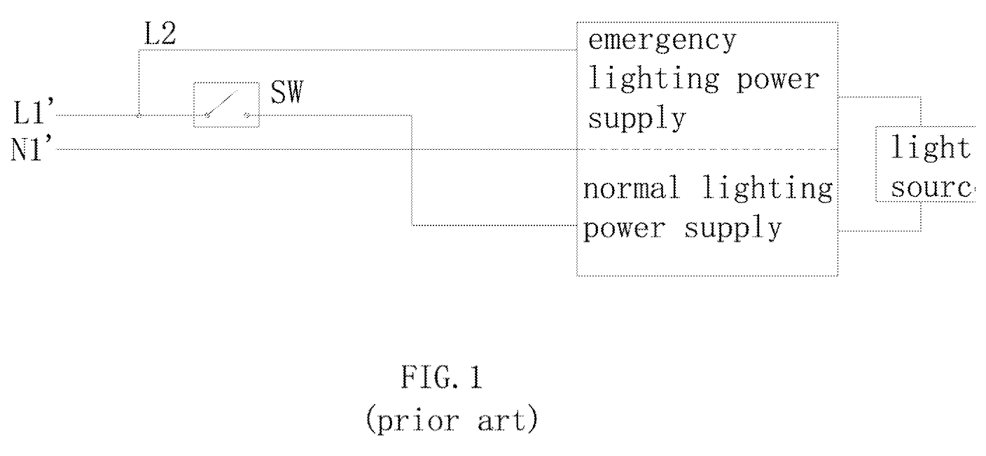

FIG. 2 is a schematic block diagram of Embodiment I of the present invention.

FIG. 3 is a first partial schematic circuit diagram of an uninterrupted power control switch of Embodiment I of the present invention.

FIG. 4 is a second partial schematic circuit diagram of the uninterrupted power control switch of Embodiment I of the present invention.

FIG. 5 is a first partial schematic circuit diagram of a switch control module of Embodiment I of the present invention.

FIG. 6 is a second partial schematic circuit diagram of the switch control module of Embodiment I of the present invention.

FIG. 7 is a schematic block diagram of Embodiment II of the present invention.

FIG. 8 is a schematic block diagram of Embodiment III of the present invention.

FIG. 9 is a schematic block diagram of Embodiment IV of the present invention.

FIG. 10 is a schematic block diagram of Embodiment V of the present invention.

### DETAILED DESCRIPTION OF THE INVENTION

To further explain the technical solutions of the present invention, a detailed description of the present invention is provided hereinafter through specific embodiments.

### Embodiment I

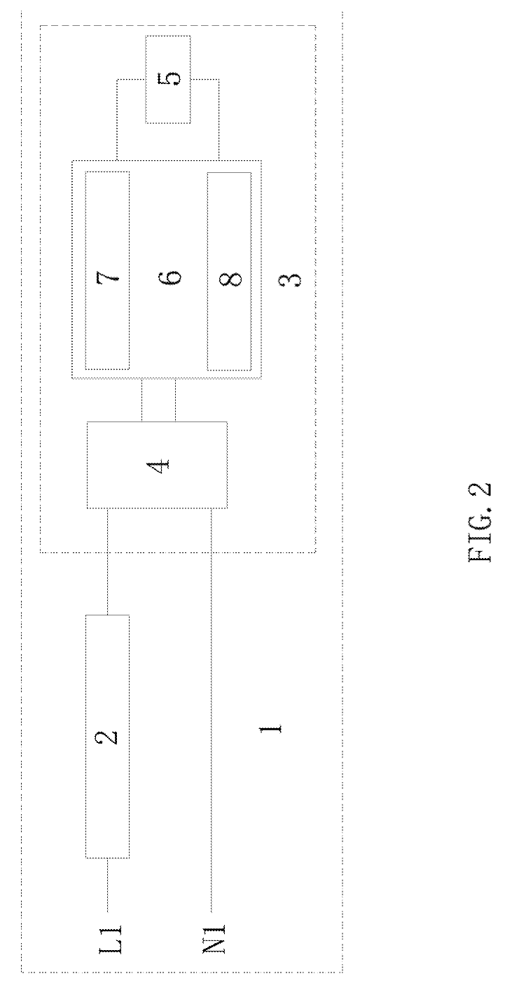

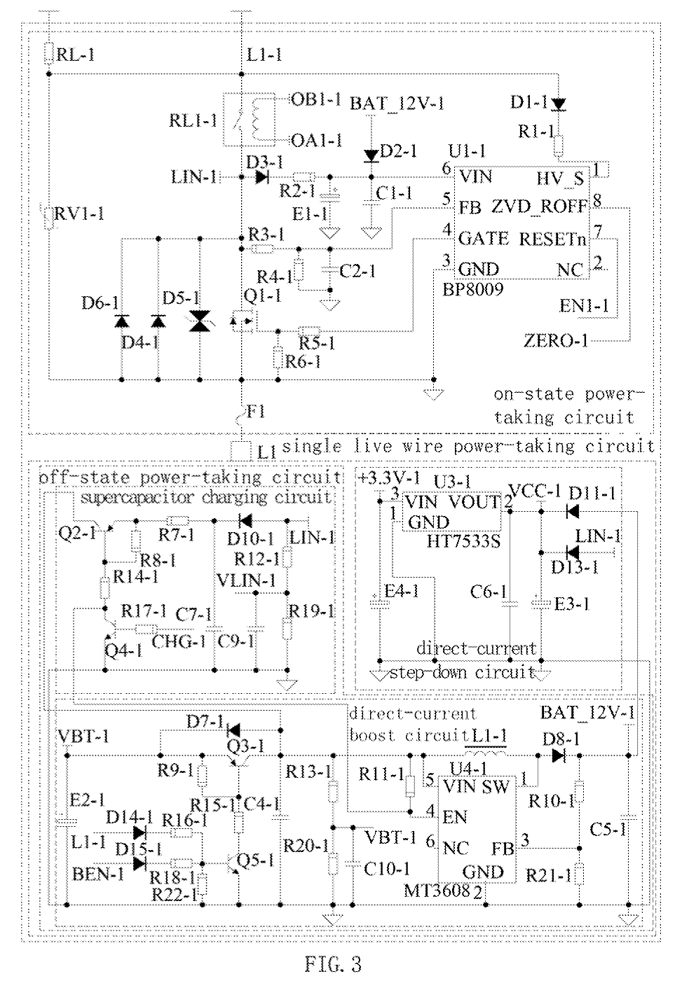

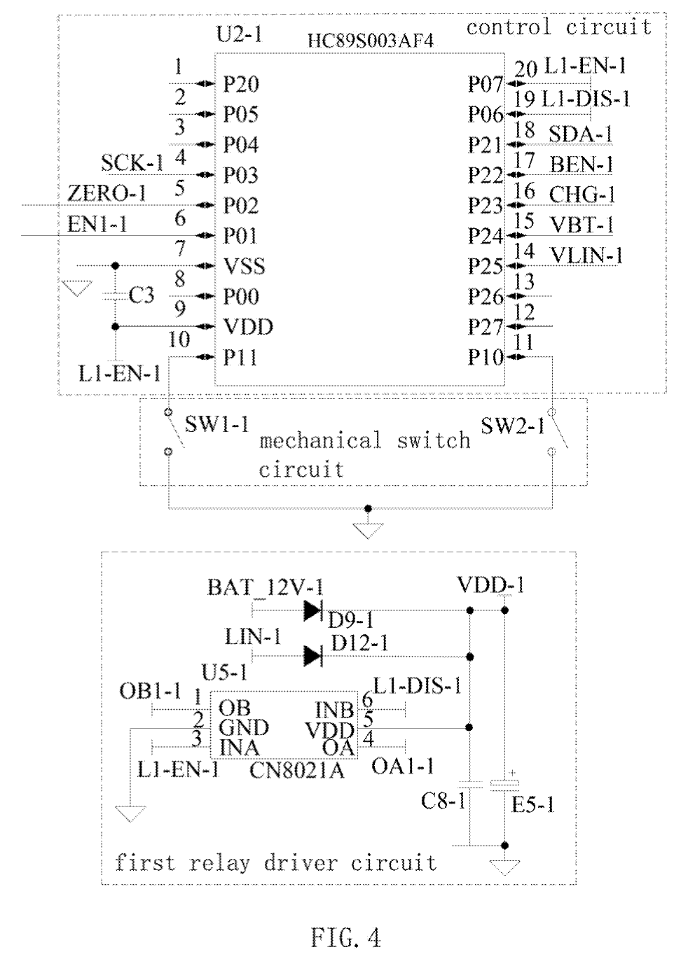

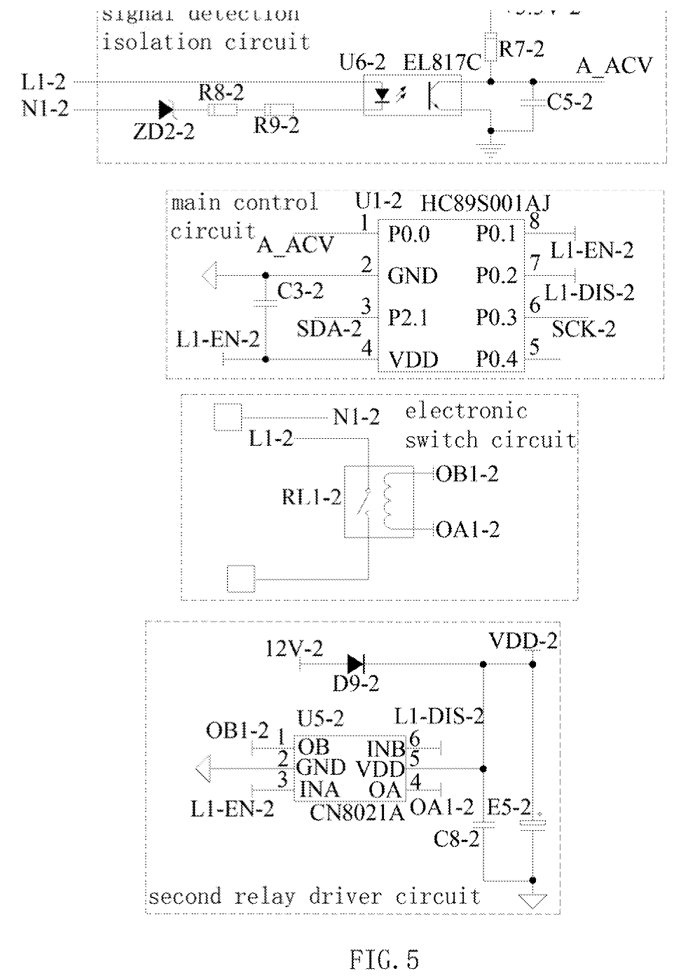

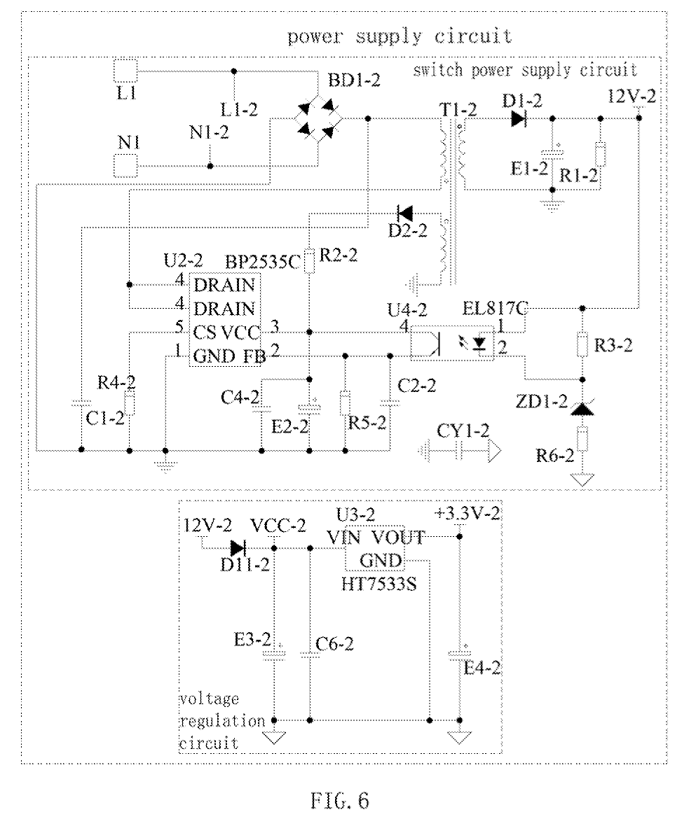

As shown in FIG. 2 to 6, in Embodiment I of the present invention, the single live wire lighting system according to the present invention comprises at least one single live wire lighting unit 1, specifically, said at least one single live wire lighting unit 1 comprises only one single live wire lighting unit 1 according to Embodiment I. Each single live wire lighting unit 1 (in this embodiment, i.e. the only one single live wire lighting unit 1) comprises a power supply live wire L1, a power supply neutral wire N1, an uninterrupted power control switch 2, and at least one lighting module 3; the uninterrupted power control switch 2 is connected in series between an input side and an output side of the power supply live wire L1, and the uninterrupted power control switch 2 is biased to an uninterrupted state that allows continuous electrical connection between the input side and the output side of the power supply live wire L1; each lighting module 3 comprises a switch control module 4, at least one light source 5, and at least one power module 6 that connects the switch control module 4 and said at least one light source 5; an input side of the switch control module 4 is connected to the output side of the power supply live wire L1 and also to the power supply neutral wire N1; the uninterrupted power control switch 2 of each single live wire lighting unit 1 is configured to send control signals; in each single live wire lighting unit 1, the switch control module 4 of each lighting module 3 receives and parses the control signals sent by the uninterrupted power control switch 2, and the switch control module 4 of each lighting module 3 correspondingly controls whether said at least one power module 6 of a respective lighting module 3 supplies power to said at least one light source 5 based on the control signals.

When installing the single live wire lighting system of the present invention on traditional power supply lines (which comprise a power supply live wire L1 and a power supply neutral wire N1, with the power supply live wire L1 connected in series with a wall switch), the uninterrupted power control switch 2 of each single live wire lighting unit 1 can directly replace the wall switch or be installed inside the wall switch and be connected in series between the input side and the output side of the power supply live wire L1, and each lighting module 3 can be directly connected to the power supply neutral wire N1 and also to the output side of the power supply live wire L1. Thus, it is evident that the single live wire lighting system of the present invention can be directly installed on traditional power supply lines without the need for rewiring, thus providing the advantage of easy installation. In addition, the user can operate the uninterrupted power control switch 2 to allow the uninterrupted power control switch 2 to send control signals that control the operation of said at least one light source 5 of each lighting module 3, thereby ensuring that the user can control the on/off state of said at least one light source 5 as needed and as usual. Moreover, the uninterrupted power control switch 2 is biased to the uninterrupted state to enable continuous electrical connection between the input side and the output side of the power supply live wire L1, thereby ensuring that an emergency lighting power supply 7 of each lighting module 3 can be continuously charged. This guarantees that the emergency lighting power supply 7 of each lighting module 3 has sufficient power to supply to said at least one light source 5 in the event of an unexpected power outage, thus ensuring the need for emergency lighting.

In Embodiment I of the present invention, said at least one power module 6 of each lighting module 3 in each single live wire lighting unit 1 comprises both an emergency lighting power supply 7 and a normal lighting power supply 8. Additionally, the switch control module 4 of each lighting module 3 of each single live wire lighting unit 1 controls whether the normal lighting power supply 8 of a respective power module 6 of a respective lighting module 3 supplies power to said at least one light source 5 based on the control signals. The emergency lighting power supply 7, the normal lighting power supply 8, and the switch control module 4 may be integrated together on one and the same circuit board (not specifically shown in the figures) or arranged independently in different circuit boards (not specifically shown in the figures).

In Embodiment I of the present invention, the uninterrupted power control switch 2 comprises a single live wire power-taking circuit, a mechanical switch circuit, and a control circuit. The single live wire power-taking circuit is connected in series between the input side and the output side of the power supply live wire L1, and the single live wire power-taking circuit is provided with a single live wire relay RL1-1 that controls power connection between the input side and the output side of the power supply live wire L1. The control circuit is powered by the single live wire power-taking circuit and is connected to the single live wire relay RL1-1 and the mechanical switch circuit. The control circuit controls, based on the signals from the mechanical switch circuit, an on/off state, an on/off frequency, and an on/off duration of the single live wire relay RL1-1.

The working principle of the uninterrupted power control switch 2 is as follows:

When the uninterrupted power control switch is biased to an uninterrupted state, the single live wire relay RL1-1 of the single live wire power-taking circuit is closed, thereby allowing continuous electrical connection between the input side and the output side of the power supply live wire L1; also, the single live wire power-taking circuit draws power from the power supply live wire L1 to ensure normal operation of the control circuit.

When a user inputs commands to the control circuit via the mechanical switch circuit, the control circuit controls the on/off state, on/off frequency, and on/off duration of the single live wire relay RL1-1 according to the input commands. This enables the output side of the power supply live wire L1 to output control signals with the corresponding on/off frequency and the on/off duration. Different on/off frequencies and on/off durations of the control signals indicate different information.

In Embodiment I of the present invention, the single live wire power-taking circuit may comprise an off-state power-taking circuit and an on-state power-taking circuit. The on-state power-taking circuit is provided with said single live wire relay RL1-1 and is connected in series between the input side and the output side of the power supply live wire L1. The on-state power-taking circuit draws power from the power supply live wire L1 when the single live wire relay RL1-1 is closed. The on-state power-taking circuit may be designed using a power-taking circuit based on a single live wire smart panel power chip U1-1 (for example, single live wire smart panel power chip of model number BP8009 from Shanghai Bright Power Semiconductor Co., Ltd.). The off-state power-taking circuit is connected to the on-state power-taking circuit and is used to supply power to the control circuit when the single live wire relay is open. The off-state power-taking circuit may comprise a supercapacitor charging circuit and a direct-current boost circuit arranged in sequence. The supercapacitor charging circuit is used for energy storage, and the direct-current boost circuit is used to boost a voltage output from the supercapacitor charging circuit when the single live wire relay RL1-1 is open. The direct-current boost circuit may use a boost chip U4-1 of model number MT3608 manufactured by Xian Aerosemi Technology Co., Ltd.

In Embodiment I of the present invention, the single live wire power-taking circuit may further comprise a direct-current step-down circuit. The direct-current step-down circuit is connected to the off-state power-taking circuit and the on-state power-taking circuit. The direct-current step-down circuit is used to convert direct-current power outputs from the off-state power-taking circuit and on-state power-taking circuit to a voltage required by the control circuit. The direct-current step-down circuit may use a linear regulator U3-1 of model number HT7533S manufactured by UTD Semiconductor Co., Ltd.

In Embodiment I of the present invention, the control circuit may be a microcontroller circuit, and the control circuit may use a microcontroller chip U2-1 of model number HC89S003AF4 manufactured by Shanghai Holychip Electronic Co., Ltd. The control circuit can be connected to the single live wire relay RL1-1 via a first relay driver circuit to control the single live wire relay RL1-1, and the first relay driver circuit may use a relay driver chip U5-1 of model number CN8021A manufactured by Shanghai Chipnorth Electronic Technology Co., Ltd. The mechanical switch circuit may comprise at least one of a micro switch SW1-1 and a micro switch SW2-1 connected to the control circuit. A User inputs commands to the control circuit by controlling on/off state of the micro switch SW1-1 and/or the micro switch SW2-1.

In Embodiment I of the present invention, the switch control module 4 may comprise a main control circuit, a power supply circuit, a signal detection isolation circuit, and an electronic switch circuit. The power supply circuit is connected to the output side of the power supply live wire L1 and also to the power supply neutral wire N1. The signal detection isolation circuit is connected to the output side of the power supply live wire L1 and also to the power supply neutral wire N1. The main control circuit is connected to the power supply circuit, the signal detection isolation circuit, and the electronic switch circuit. The main control circuit and the signal detection isolation circuit are powered by the power supply circuit. The main control circuit receives the control signals sent by the uninterrupted power control switch 2 through the signal detection isolation circuit, and the main control circuit correspondingly controls an on/off state of the electronic switch circuit based on the information of the control signals. The electronic switch circuit is connected to a corresponding power module 6.

In Embodiment I of the present invention, the power supply circuit may comprise a switch power supply circuit and a voltage regulation circuit connected in sequence. The voltage regulation circuit provides required operating voltages to the main control circuit and the signal detection isolation circuit. The power supply circuit may use a constant voltage chip U2-1 of model number BP2535C manufactured by Shanghai Bright Power Semiconductor Co., Ltd, and the voltage regulation circuit may use a linear regulator U3-2 of model number HT7533S manufactured by UTD Semiconductor Co., Ltd.

In Embodiment I of the present invention, the signal detection isolation circuit comprises a resistor R7-2, a resistor R8-2, a resistor R9-2, a capacitor C5-2, a Zener diode ZD2-2, and an optocoupler U6-2. A positive electrode of an input side of the optocoupler U6-2 is connected to the output side of the power supply live wire L1. A negative electrode of the input side of the optocoupler U6-2 is connected to a negative electrode of the Zener diode ZD2-2 through the resistor R8-2 and the resistor R9-2. A positive electrode of the Zener diode ZD2-2 is connected to the power supply neutral wire N1. A positive electrode of an output side of the optocoupler U6-2 is connected to the main control circuit and a first terminal of the capacitor C5-2, and the positive electrode of the output side of the optocoupler U6-2 is also connected to the power supply circuit through the resistor R7-2. A negative electrode of the output side of the optocoupler U6-2 and a second terminal of the capacitor C5-2 are grounded. When the control circuit causes the output side of the power supply live wire L1 to output control signals, the control signals correspondingly control an on/off state of the input side of the optocoupler U6-2, thereby causing the positive electrode of the output side of the optocoupler U6-2 to create corresponding pulse signals. The pulse signals are input to the main control circuit, and the main control circuit obtains the frequency and duty cycle information of the pulse signals to parse the information contained in the control signals. The optocoupler U6-2 serves the functions of isolation protection and signal conversion, preventing damage to the main control circuit, while the Zener diode ZD2-2 serves a voltage-limiting function to protect the optocoupler U6-2.

In Embodiment I of the present invention, the electronic switch circuit may comprise a relay RL1-2. The main control circuit is connected to the relay RL1-2 via a second relay driver circuit to control the on/off state of the relay RL1-2. The second relay driver circuit may use a relay driver chip U5-2 with of model number CN8021A manufactured by Shanghai Chipnorth Electronic Technology Co., Ltd.

In Embodiment I of the present invention, the electronic switch circuit can be used to control whether the normal lighting power supply 8 of a corresponding power module 6 is connected to the output side of the power supply live wire L1. When the normal lighting power supply 8 is connected to the output side of the power supply live wire L1, the normal lighting power supply 8 supplies power to a corresponding light source 5, causing the corresponding light source 5 to illuminate. When the normal lighting power supply 8 is not connected to the output side of the power supply live wire L1, the normal lighting power supply 8 does not supply power to the corresponding light source 5, causing the corresponding light source 5 to turn off.

In Embodiment I of the present invention, the main control circuit may be a microcontroller circuit, and the main control circuit may use a microcontroller chip U1-2 with of model number HC89S001AJ manufactured by Shanghai Holychip Electronic Co., Ltd.

### Embodiment II

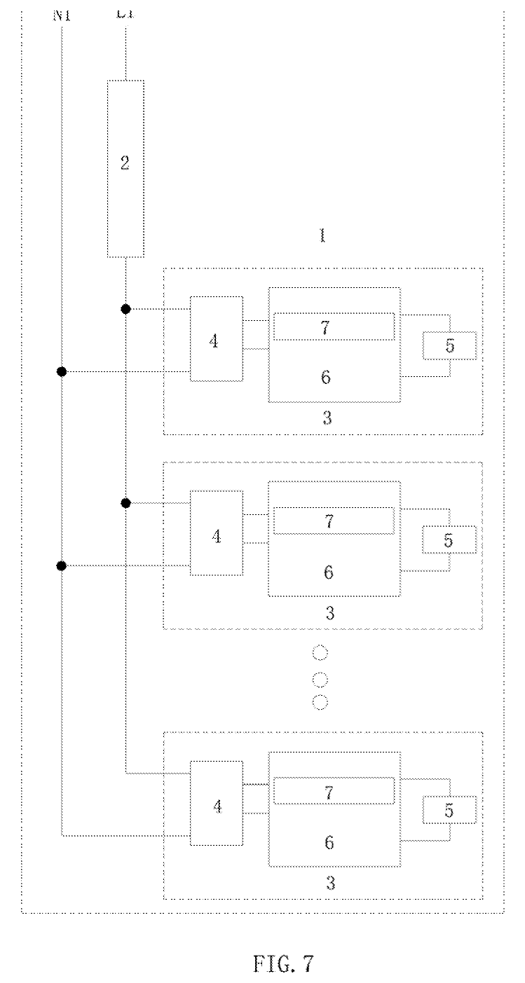

As shown in FIG. 7, in Embodiment II of the present invention, the single live wire lighting system according to the present invention comprises one single live wire lighting unit 1, and the single live wire lighting unit 1 is provided with a plurality of lighting modules 3 connected in parallel. The difference between each of the plurality of light modules 3 of the single live wire lighting unit 1 of Embodiment II and the lighting module 3 of the single live wire lighting unit 1 in Embodiment I is that, the power module 6 of each of the plurality of lighting modules 3 in the single live wire lighting unit 1 of Embodiment II only comprises the emergency lighting power supply 7. The switch control module 4 of each of the plurality of lighting modules 3 controls whether the emergency lighting power supply 7 of the power module 6 of each of the plurality of lighting modules 3 supplies power to a corresponding light source 5 or not based on the information of the control signals. Circuit structures of the switch control module 4 of each of the plurality of lighting modules 3 in Embodiment II are the same as those of disclosed in Embodiment I. The electronic switch circuit of each switch control module 4 of Embodiment II is used to control whether the emergency lighting power supply 7 of each power module 3 outputs power to the corresponding light source 5. The electronic switch circuit of each switch control module 4 in Embodiment II may be arranged at an output end of a corresponding emergency lighting power supply 7.

### Embodiment III

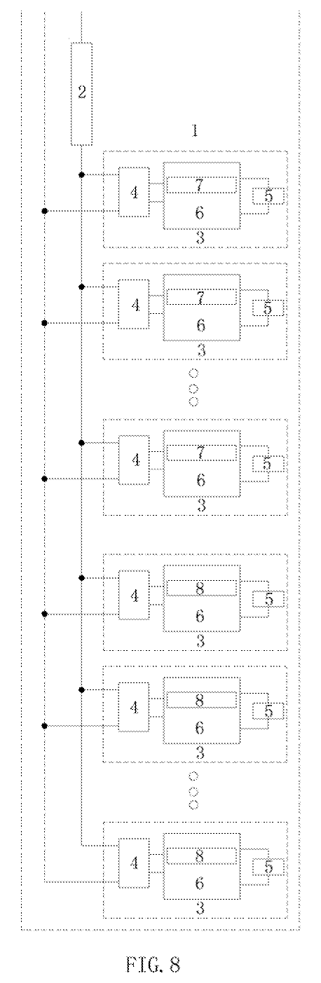

As shown in FIG. 8, in Embodiment III of the present invention, the single live wire lighting system according to the present invention comprises one single live wire lighting unit 1, and the single live wire lighting unit 1 is provided with a plurality of lighting modules 3 connected in parallel. In Embodiment III, the power module 6 of each of some of the plurality of lighting modules 3 only comprises the normal lighting power supply 8, while the power module 6 of each of the remaining of the plurality of lighting modules 3 only comprises the emergency lighting power supply 7. In each of the plurality of lighting modules 3 where the power module 6 only comprises the emergency lighting power supply 7, the switch control module 4 of a respective lighting module 3 controls whether the emergency lighting power supply 7 of the power module 6 supplies power to a respective light source 5 based on the information of the control signals. In each of the plurality of lighting modules 3 where the power module 6 only comprises the normal lighting power supply 8, the switch control module 4 of a respective lighting module 3 controls whether the normal lighting power supply 8 of the power module 6 supplies power to a respective light source 5 based on the information of the control signals.

### Embodiment IV

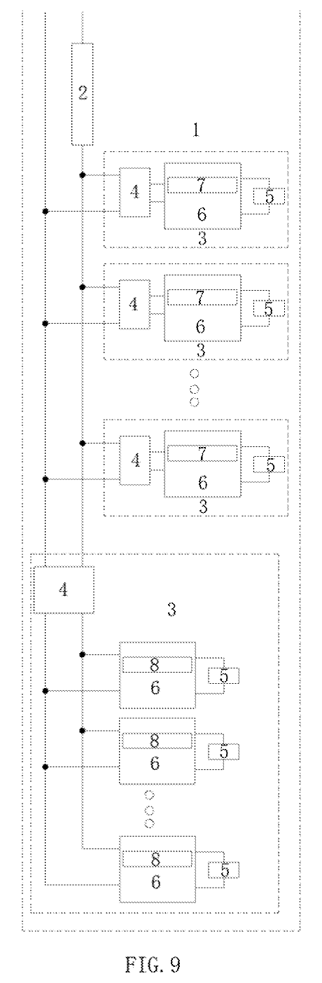

As shown in FIG. 9, in Embodiment IV of the present invention, the single live wire lighting system according to the present invention comprises one single live wire lighting unit 1, and the single live wire lighting unit 1 is provided with a plurality of lighting modules 3 connected in parallel. In Embodiment IV, some of the plurality of lighting modules 3 are each provided with only one power module 6 (which comprises the emergency lighting power supply 7) and only one light source 5, while at least one of the remaining of the plurality lighting modules 3 is provided with a plurality of power modules 6 (each of which comprises the normal lighting power supply 8) connected in parallel, and a plurality of light sources 5 connected respectively to the plurality of power modules 6. In each of said at least one of the remaining of the plurality lighting modules 3 provided with the plurality of power modules 6 connected in parallel and the plurality of light sources 5 connected respectively to the plurality of power modules 6, the switch control module 4 of each of said at least one of the remaining of the plurality lighting modules 3 simultaneously controls whether the plurality of power modules 6 of each of said at least one of the remaining of the plurality lighting modules 3 supply power to the plurality of light sources 5 or not.

### Embodiment V:

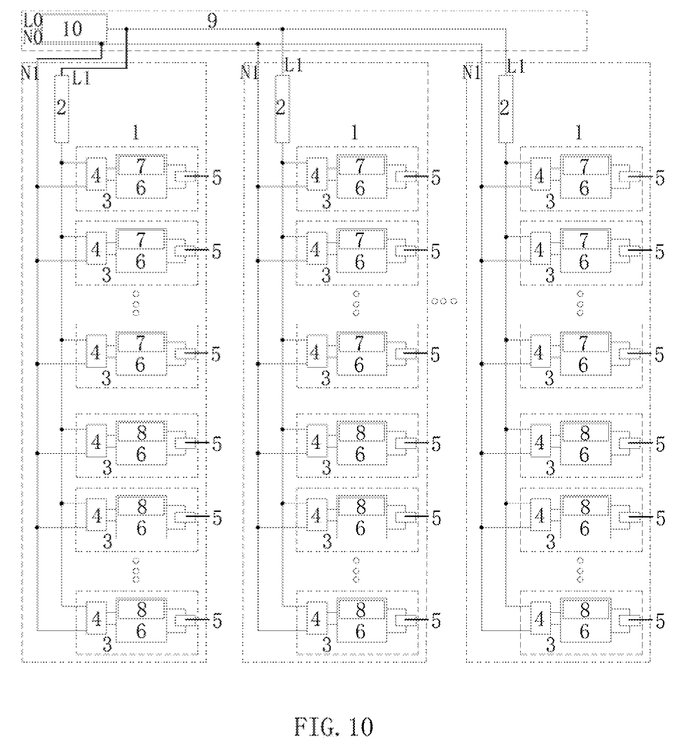

As shown in FIG. 10, in Embodiment V of the present invention, the single live wire lighting system according to the present invention comprises a plurality of single live wire lighting units 1, and the plurality of single live wire lighting units 1 are arranged in parallel. In addition, the single live wire lighting system according to the present invention further comprises a master control mechanism 9; the master control mechanism 9 can simultaneously control the plurality of single live wire lighting units 1.

In Embodiment V of the present invention, the master control mechanism 9 comprises a main live wire LO, a main neutral wire NO, and an uninterrupted power master control switch 10 connected in series between the input side and the output side of the main live wire LO. The input side of the power supply live wire L1 of each of the plurality of single live wire lighting units 1 is connected to the output side of the main live wire LO; the power supply neutral wire N1 of each of the plurality of single live wire lighting units 1 is connected to the main neutral wire NO. The uninterrupted power master control switch 10 is used to send master control signals, which are of a same type as the control signals described above. The switch control module 4 of each light module 3 of each of the plurality of single live wire lighting units 1 can receive the master control signals sent by the uninterrupted power master control switch 10, and the switch control module 4 of each lighting module 3 controls whether the power module 6 of a respective lighting module 3 supplies power to a respective light source 5 based on the information of the master control signals. With such arrangements, the present invention allows the uninterrupted power master control switch 10 to simultaneously control the plurality of single live wire lighting unit 1, thereby facilitating users to use.

In Embodiment V of the present invention, circuit structures of the uninterrupted power master control switch 10 can be the same as those of the uninterrupted power control switch 2 described above.

It should be noted that the type of control signals provided in the above embodiments are wired signals, and the control signals are loaded onto the power supply live wire L1. However, the present invention is not limited thereto; the control signals may also be wireless control signals, and correspondingly, the uninterrupted power control switch 2 and the switch control module 4 may be provided with corresponding wireless communication modules to enable transmission and reception of wireless control signals.

The above embodiments and illustrations are not intended to limit the form and style of the product of the present invention. Any appropriate variations or modifications made by those of ordinary skill in the art shall be considered as falling within the scope of the patent of the present invention.

What is claimed is:

1. A single live wire lighting system, comprising at least one single live wire lighting unit; each of said at least one single live wire lighting unit comprises a power supply live wire, a power supply neutral wire, an uninterrupted power control switch, and at least one lighting module; the uninterrupted power control switch is connected in series between an input side and an output side of the power supply live wire, and the uninterrupted power control switch is based to an uninterrupted state that allows continuous electrical connection between the input side and the output side of the power supply live wire; each of said at least one lighting module comprises a switch control module, at least one light source, and at least one power module that connects the switch control module and said at least one light source; an input side of the switch control module is connected to the output side of the power supply live wire and also to the power supply neutral wire, each of said at least one power module of each of said at least one lighting module of each of said at least one single live wire lighting unit comprises at least one of an emergency lighting power supply and a normal lighting power supply to supply power to a respective light source, and at least one of said at least one power module comprises the emergency lighting power supply;
the uninterrupted power control switch of each of said at least one single live wire lighting unit is configured to send control signals; in each of said at least one single live wire lighting unit, the switch control module of each of said at least one lighting module receives and parses the control signals sent by the uninterrupted power control switch, and the switch control module of each of said at least one lighting module controls whether a respective power module of a respective lighting module supplies power to a respective light source based on the control signals.

2. The single live wire lighting system of claim 1, wherein each of said at least one power module of each of said at least one lighting module of each of said at least one single live wire lighting unit comprises both the emergency lighting power supply and the normal lighting power supply; the switch control module of each of said at least one lighting module controls whether the normal lighting power supply of a respective power module of a respective lighting module supplies power to a respective light source based on the control signals.

3. The single live wire lighting system of claim 1, wherein in each of said at least one lighting module where each of said at least one power module only comprises the emergency lighting power supply, the switch control module of each of said at least one lighting module where each of said at least one power module only comprises the emergency lighting power supply controls whether the emergency lighting power supply of a respective power module of a respective lighting module supplies power to a respective light source based on the control signals.

4. The single live wire lighting system of claim 1, wherein in each of said at least one lighting module where each of said at least one power module only comprises the normal lighting power supply, the switch control module of each of said at least one lighting module where each of said at least one power module only comprises the normal lighting power supply controls whether the normal lighting power supply of a respective power module of a respective lighting module supplies power to a respective light source based on the control signals.

5. The single live wire lighting system of claim 1, wherein the control signals are wireless control signals, or the control signals are wired signals loaded onto the power supply live wire.

6. The single live wire lighting system of claim 1, further comprising a master control mechanism; the master control mechanism comprises a main live wire,a main neutral wire, and an uninterrupted power master control switch connected in series between an input side and an output side of the main live wire; the input side of the power supply live wire of each of said at least one single live wire lighting unit is connected to the output side of the main live wire;the power supply neutral wire of each of said at least one single live wire lighting unit is connected to the main neutral wire;
the uninterrupted power master control switch is configured to send master control signals; the switch control module of each of said at least one lighting module of each of said at least one single live wire lighting unit receives the master control signals sent by the uninterrupted power master control switch, and the switch control module of each of said at least one lighting module controls whether a respective power module of a respective lighting module supplies power to a respective light source based on the master control signals.

7. The single live wire lighting system of claim 6, wherein circuit structures of the uninterrupted power master control switch are the same as those of the uninterrupted power control switch.

8. The single live wire lighting system of claim 1, wherein the uninterrupted power control switch comprises a single live wire power-taking circuit, a mechanical switch circuit, and a control circuit;
the single live wire power-taking circuit is connected in series between the input side and the output side of the power supply live wire, and the single live wire power-taking circuit is provided with a single live wire relay that controls power connection between the input side and the output side of the power supply live wire;
the control circuit is powered by the single live wire power-taking circuit and is connected to the single live wire relay and the mechanical switch circuit;
the control circuit controls, based on signals from the mechanical switch circuit, an on/off state, an on/off frequency, and an on/off duration of the single live wire relay.

9. The single live wire lighting system of claim 8, wherein the switch control module comprises a main control circuit, a power supply circuit, a signal detection isolation circuit, and an electronic switch circuit; the power supply circuit is connected to the output side of the power supply live wire and also to the power supply neutral wire; the signal detection isolation circuit is connected to the output side of the power supply live wire and also to the power supply neutral wire; the main control circuit is connected to the power supply circuit, the signal detection isolation circuit, and the electronic switch circuit; the main control circuit and the signal detection isolation circuit are powered by the power supply circuit; the main control circuit receives the control signals sent by the uninterrupted power control switch through the signal detection isolation circuit, and the main control circuit correspondingly controls an on/off state of the electronic switch circuit based on the control signals; the electronic switch circuit is connected to a corresponding power module.

10. The single live wire lighting system of claim 9, wherein the signal detection isolation circuit comprises a resistor R7-2, a resistor R8-2, a resistor R9-2, a capacitor C5-25-2, a Zener diode ZD2-2, and an optocoupler U6-2; a positive electrode of an input side of the optocoupler U6-2 is connected to the output side of the power supply live wire; a negative electrode of the input side of the optocoupler U6-2 is connected to a negative electrode of the Zener diode ZD2-2 through the resistor R8-2 and the resistor R9-2; a positive electrode of the Zener diode ZD2-2 is connected to the power supply neutral wire; a positive electrode of an output side of the optocoupler U6-2 is connected to the main control circuit and a first terminal of the capacitor C5-25-2, and the positive electrode of the output side of the optocoupler U6-2 is also connected to the power supply circuit through the resistor R7-2; a negative electrode of the output side of the optocoupler U6-2 and a second terminal of the capacitor C5-25-2 are grounded.
